(19) United States
(12) Patent Application Publication
(10) Pub. No.: US 2011/0228132 A1
(43) Pub. Date: Sep. 22, 2011

(54) CAMERA AND IMAGE COMPOSITION PROGRAM

(75) Inventors: Kazuya UMEYAMA, Tokyo (JP); Tomotaka SHINODA, Tokyo (JP)

(73) Assignee: NIKON CORPORATION, Tokyo (JP)

(21) Appl. No.: 13/018,526

(22) Filed: Feb. 1, 2011

(30) Foreign Application Priority Data
Feb. 24, 2010 (JP) 2010-038383

(51) Int. Cl. H04N 5/262; H04N 5/76

(52) U.S. Cl. 348/231.99; 348/239; 348/E05.051

(57) ABSTRACT

A camera includes: an image-capturing unit; a storage unit; a positional deviation amount determination unit that determines an amount of positional deviation in each of a plurality of frame images; an image composition unit that positionally matches the frame images based upon the results of determination and performs additive composition; a decision unit that decides whether or not each of the frame images is suitable for a subject for the additive composition; and a control unit that, if a negative decision is reached for at least one of the frame images, selects as a source image a frame image decided as suitable, takes a duplicate image as a subject for the additive composition instead of the frame image decided to be negative, and controls the image composition unit so as to perform the additive composition while relatively shifting one of the duplicate and the source image by a predetermined amount.

### INCORPORATION BY REFERENCE

The disclosure of the following priority application is herein incorporated by reference:

Japanese Patent Application No. 2010-038383 filed Feb. 24, 2010.

### BACKGROUND OF THE INVENTION

1. Field of the Invention

The present invention relates to a camera, and to an image composition program.

2. Description of Related Art

Japanese Laid-Open Patent Publication 2001-86398 discloses a technique of performing image capture by division of photography into a plurality of exposures that are performed in succession a plurality of times, and of obtaining a single exposed image by adding together the image signals obtained by this plurality of exposures (this process will hereinafter be termed “additive composition”).

### SUMMARY OF THE INVENTION

With this prior art technique, the possibility was not taken into consideration that image frames that were difficult to add together might be created due to the image deviation between successive frames being too great. Due to this, in some cases, there was the problem that it was not possible to perform position matching between frames, and that it was not possible to perform adequate additive composition of the images.

According to the 1st aspect of the present invention, a camera comprises: an image-capturing unit that captures successive images of a photographic subject, and generates a plurality of frame images; a storage unit that temporarily stores the plurality of frame images generated by the image-capturing unit; a positional deviation amount determination unit that determines an amount of positional deviation generated in each of the plurality of frame images; an image composition unit that, on the basis of the results of determination by the positional deviation amount determination unit, positionally matches the plurality of temporarily stored frame images, and then performs additive composition thereof; a decision unit that decides whether or not each of the plurality of frame images is suitable to be a subject for the additive composition, on the basis of the amounts of positional deviation; and a control unit that, if a negative decision has been reached by the decision unit for at least one of the plurality of frame images, selects as a source image a frame image that has been decided by the decision unit as being suitable, takes a duplicate image of the source image as a subject for the additive composition instead of the frame image for which a negative decision has been reached by the decision unit, and controls the image composition unit so as to perform the additive composition while relatively shifting one of the duplicate image and the source image by a predetermined amount relative to the other.

According to the 2nd aspect of the present invention, it is preferred that in a camera according to the 1st aspect, if two or more frame images are present for which a negative decision has been reached by the decision unit, the control unit creates two or more duplicate images from the single source image, takes the duplicate images as subjects for the additive composition and controls the image composition unit so that it performs the additive composition while shifting the two or more duplicate images by predetermined amounts in different directions relative to the single source image.

According to the 3rd aspect of the present invention, it is preferred that in a camera according to the 1st aspect, if two or more frame images are present for which a negative decision has been reached by the decision unit, the control unit creates the duplicate images from each of two or more source images, takes the duplicate images as subjects for the additive composition and controls the image composition unit so that it performs the additive composition while relatively shifting one of each of the duplicate images and source image by a predetermined amount relative to the other.

According to the 4th aspect of the present invention, it is preferred that in a camera according to the 1st aspect, according as to whether or not the magnitudes of the amounts of positional deviation occurring between a reference frame image and the other frame images other than the reference frame image are less than a predetermined value, the decision unit makes the decision as to suitability or unsuitability in relation to the other frame images, the reference frame image being determined in advance among the plurality of frames that are temporarily stored in the storage unit.

According to the 5th aspect of the present invention, the control unit of a camera according to the 4th aspect may select the reference frame image as the source image, and control the image processing unit so as to create the duplicate image by duplicating the selected source image.

According to the 6th aspect of the present invention, a camera comprises: an image-capturing unit that captures successive images of a photographic subject, and generates a plurality of frame images; a storage unit that temporarily stores the plurality of frame images generated by the image-capturing unit; a determination unit that determines a relative amount of positional deviation between the plurality of frame images; a decision unit that makes a decision as to whether or not the amount of positional deviation is larger than a predetermined value; and an additive composition unit that: performs additive composition of the plurality of frame images after having performed position matching thereof on the basis of the amounts of positional deviation, if the amounts of positional deviation of all of the plurality of frame images are decided to be smaller than the predetermined value by the decision unit, and selects at least one frame image that has been decided by the decision unit as being suitable as a source image, relatively shifts one of a duplicate of the source image and the source image by a predetermined amount relative to the other, and performs the additive composition using the duplicate image instead of the frame image that has been decided as being unsuitable, if the amount of positional deviation of at least one of the plurality of frame images is decided to be greater than the predetermined value by the decision unit.

According to the 7th aspect of the present invention, a manufactured program product that can be read by a computer, on which is recorded an image composition program that can be executed by a computer. The image composition program comprises: a first process of reading in a plurality of frame images that have been captured successively; a second process of deciding upon amounts of positional deviation occurring between the plurality of frame images; a third process of deciding upon its suitability or unsuitability as an additive composition subject for each of the plurality of frame images that have been read in, if additive composition is performed after having performed position matching of the plurality of frame images on the basis of the results of decision in the second process; a fourth process of selecting a frame image that has been decided to be suitable as a source image, and creating a duplicate image by duplicating the source image; a fifth process of substituting the duplicate image for a frame image that has been decided as being unsuitable; a sixth process of shifting the duplicate image with respect to the source image by a predetermined amount; and a seventh process of performing the additive composition of the plurality of frame images executed after the first process through the sixth process.

According to the present invention, it is possible to adequately perform the additive composition of the plurality of frame images successively captured.

### BRIEF DESCRIPTION OF THE DRAWINGS

FIG. 1 is a figure for explanation of an example of the structure of an electronic camera according to an embodiment of the present invention;

FIG. 2 is a figure showing an example of a case in which six frames have been shot in succession by continuous shooting photography;

FIG. 3 is a figure for explanation of position matching in the case shown in FIG. 2;

FIG. 4 is a flow chart for explanation of the flow of a control procedure for hand-held night scene photography;

FIG. 5 is a table showing an example of a relationship between the value of a counter “a” and a direction of displacement;

FIG. 6 is a figure showing an example of a case in which a plurality of idiosyncratic images have been shot;

FIG. 7 is a figure for explanation of the position matching in the case shown in FIG. 6; and

FIG. 8 is a figure showing an example of a computer device.

### DESCRIPTION OF THE PREFERRED EMBODIMENTS

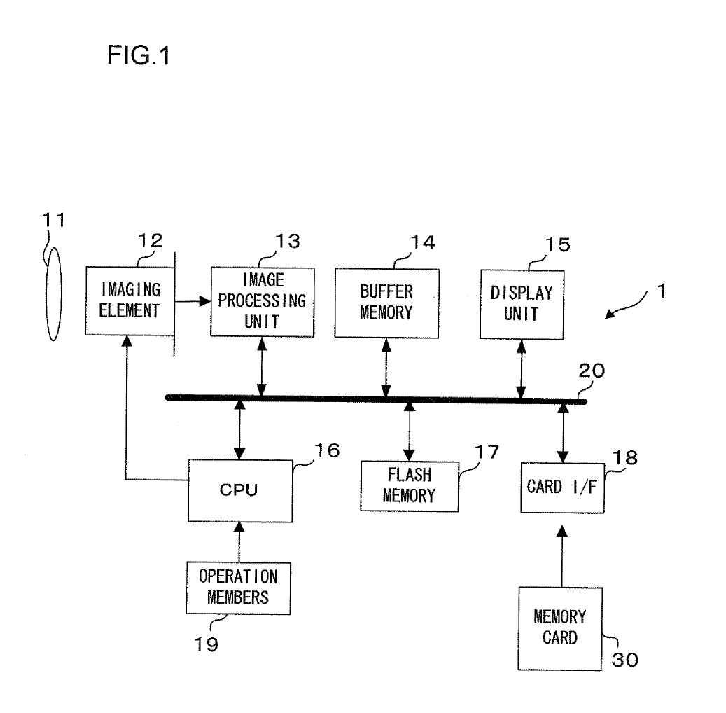

In the following, embodiments of the present invention will be explained with reference to the drawings. FIG. 1 is a block diagram for explanation of an example of the structure of an electronic camera 1 according to an embodiment of the present invention. The electronic camera in FIG. 1 includes a photographic optical system 11, an imaging element 12, an image processing unit 13, a buffer memory 14, a display unit 15, a CPU 16, a flash memory 17, a card interface (I/F) 18, and operation members 19.

The CPU 16, the flash memory 17, the card interface 18, the image processing unit 13, the buffer memory 14, and the display unit 15 are all connected together via a bus 20.

The photographic optical system 11 includes a plurality of lens groups that include a zoom lens and a focusing lens, and forms an image of the photographic subject upon a light reception surface of the imaging element 12. It should be understood that in FIG. 1, for the sake of simplicity, the photographic optical system 11 is shown as having only one lens.

The imaging element 12 is built from a CMOS image sensor or the like in which light reception elements are arranged in a two dimensional array so that they define a light reception surface. This imaging element 12 performs photoelectric conversion upon an image created by a ray bundle that has passed through the photographic optical system 11, and generates a digital image signal. This digital image signal is inputted to the image processing unit 13.

The image processing unit 13 performs various types of image processing upon the digital image data (color interpolation processing, tone conversion processing, contour enhancement processing, white balance adjustment processing, and so on). Moreover, it also performs composition processing (position matching and addition) related to a hand-held night scene photographic mode that will described hereinafter.

The display unit 15 is built as a liquid crystal panel or the like, and displays images and operation menu screens according to commands from the CPU 16. The buffer memory 14 temporarily stores digital image data for processes before and after the image processing by the image processing unit 13. And the flash memory 17 stores a program that is executed by the CPU 16, and also stores table data that will be described hereinafter.

The CPU 16 controls the various operations performed by the electronic camera 1 by executing a program stored in the flash memory 17. In particular, the CPU 16 performs control of AF (auto focus) operation and also performs automatic exposure (AE) calculation. This AF operation, for example, may employ a contrast detection method that obtains the focal position of the focusing lens (not shown in the figures) on the basis of contrast information in the through image. The through image is an image for monitoring, and is acquired by the imaging element 12 repeatedly on a fixed cycle (for example at 60 frames per second) before release actuation.

The memory card interface 18 has a connector (not shown in the figures), and a storage medium 30 such as a memory card or the like is connected to this connector. The memory card interface 18 performs writing of data onto this connected storage medium 30, and reading of data from the connected storage medium 30. The storage medium 30 may be a memory card that includes a semiconductor memory, or a hard disk drive or the like.

The operation members 19 include a release button and a menu switch and so on. When operated in various ways, these operation members 19 send operation signals corresponding to photographic operation, mode changeover operation, menu selection operation and so on to the CPU 16.

The electronic camera 1 of this embodiment has a photographic mode called the hand-held night scene photographic mode. This photographic mode is a photographic mode in which the electronic camera 1 is not fixedly mounted upon a tripod, but performs photography of a night scene while being casually held in the user's hand. Since this embodiment is specially characterized by its control of photography in the hand-held night scene photographic mode, the following explanation will be focused on the processing during this hand-held night scene photographic mode.

Sequential Photography Over N Frames

Generally, night scene photography requires a long exposure time, because the photographic subject is relatively dark. On the other hand, during hand-held photography, there is a fear that blurring of the photographic image may take place due to shaking, if the exposure time is longer than an exposure time Tlimit that is so called hand shake limitation exposure time limit. If the focal length of the photographic optical system 11 is f (in mm), this exposure time Tlimit may, for example, be taken as being 1/f (in seconds) (when converted to a 35 mm size camera system).

Since in normal night scene photography it is necessary to set the exposure time to a longer exposure time than the exposure time Tlimit, in the prior art it has been difficult to perform hand-held photography without the occurrence of blurring due to hand shaking taking place. Thus, in the hand-held night scene photographic mode, photography is performed by dividing the total required exposure time over a plurality of frames (taken as being N in number) that are shot successively (i.e., by continuous shooting photography), and the signals for the N frame images that have been obtained by these N shots are added together by a per se known digital calculation technique, so as to produce a single image that corresponds to an adequately long exposure.

The CPU 16 determines the exposure time Tdiv for photography of each frame by dividing the required total exposure time T into equal parts. In this case, the CPU 16 determines the number of frames N that are to be continuously shot so as to be the minimum that results in the exposure time Tdiv for photography of each frame being shorter than the exposure time Tlimit described above. The exposure time T is the exposure time that is determined by automatic exposure calculation (AE) in order to obtain appropriate exposure. The CPU 16, for example, may perform automatic exposure calculation (AE) on the basis of the value of the image signal from which the above described through image is created, and may determine the exposure time T on the basis of the average brightness of that through image. And the CPU 16 obtains the exposure time Tdiv that satisfies T=N×Tdiv with the number of frames N that are to be continuously shot being the minimum possible, and under the proviso that the exposure time Tdiv for each frame is shorter than the exposure time Tlimit.

Adding the N Images Together

The CPU 16 adds together the N images that have been photographed in these N shots of continuous shooting photography, after having performed position matching between them. For example, the CPU 16 may perform edge detection on the basis of image signals (around 60 pixels each) included in some predetermined region in each image (i.e. a region that includes a photographic subject that is common to all of the images), and may perform position matching of the N images so as to align together the positions of the pixels on those edges.

Processing for Unsuitable Images

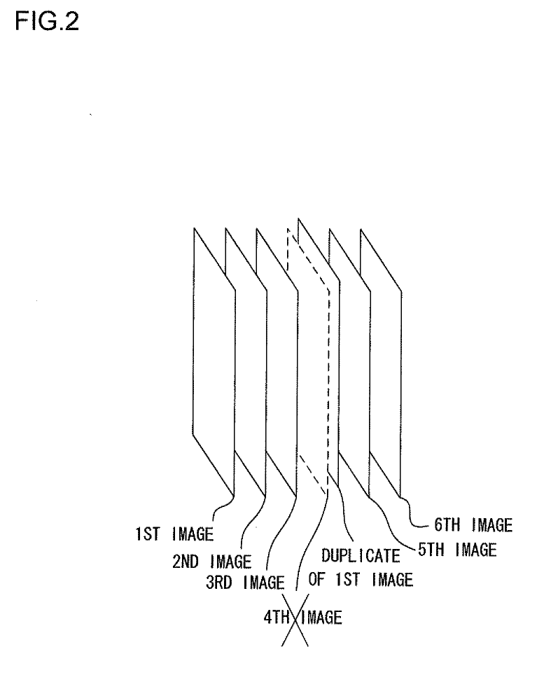

However sometimes it is the case that, among the N images that have been photographed in the N shots of continuous shooting photography, one idiosyncratic image has been photographed for which the amount of image blur is large as compared with the previous and subsequent images. In this case, in the addition process, instead of this idiosyncratic image, the CPU 16 uses a duplicate of some other one of the images (termed the source image) among the N images that is not idiosyncratic (i.e. the CPU uses this duplicate image in the addition process). In other words, the CPU 16 takes this duplicate image that is a duplicate of the source image as the subject for additive composition. FIG. 2 is a figure showing an example of a case in which continuous shooting photography has been performed N=6 times, thus resulting in six frame images. In FIG. 2, it is supposed that a large amount of image blur took place when the user was taking the photograph of the fourth image, so that the result is that this image is idiosyncratic. In order to cope with this, from among the images 1 through 3, 5, and 6 that are not idiosyncratic, the CPU 16 duplicates, for example, the first image, and takes this duplicate image as being a substitute fourth image while eliminating from the addition process the original idiosyncratic fourth image in which a large amount of image blur had taken place. By doing this, in the addition, the first image that has thus been duplicated comes to be added into the final total more times (in this example, twice) as compared to the images of the other frames.

Generally random noise, i.e. so called analog noise, is present in any image photographed by any electronic camera. Since this is random noise, it changes stochastically from one moment to the next, and thus the noise included in a sequence of image frames photographed by continuous shooting photography is generated in a completely different state at each different moment of shooting. Generally, if the images of mutually different frames are added together, the random noise included in each frame tends to be cancelled out by the random noise in the other frames and thus, the influence of random noise is reduced.

However if as described above a duplicate image of a source frame is used as a substitute for the image of some frame that is idiosyncratic, the image of the frame that is used for duplication comes to be added into the final result more times, as compared to the images of the other frames. Due to this, the mutual cancellation of the random noise included in the frame that is used for duplication by the random noise in the other frames becomes poorer. In other words, there is the possibility that, in the final image after addition, the random noise included in the frame that is used for duplication will become more conspicuous.

Noise Reduction Processing

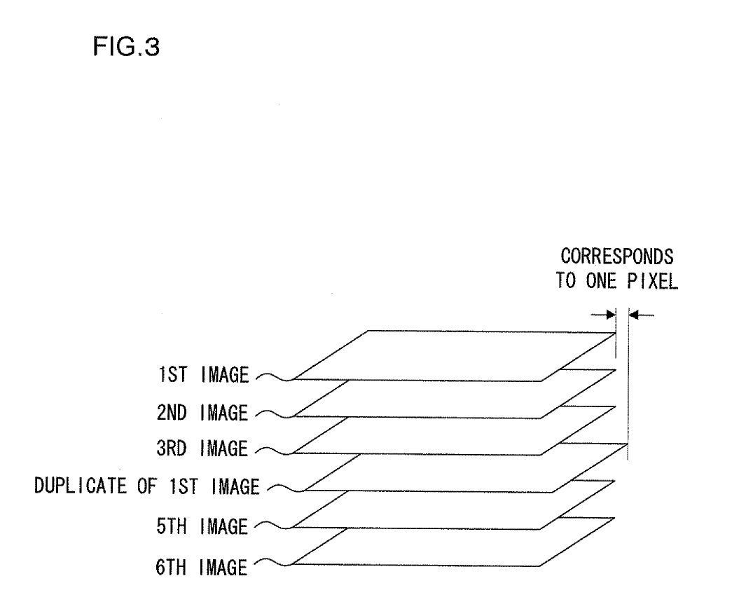

The CPU 16 performs the following processing if some idiosyncratic image has been replaced by a duplicate image of another source frame. That is, for those frame images that are to be added in a plurality of times, the CPU 16 performs fine position adjustment before addition, so as to shift the duplicate image with respect to its source image by the amount of one pixel in any of the directions up, down, left, and right in terms of the alignment of the pixels that make up the image. FIG. 3 is a figure for explanation of this fine position adjustment in the case shown in the FIG. 2 example. In FIG. 3, the duplicate of the first image that is the substitute image for the fourth image is shifted by the amount of one pixel in the rightwards direction with respect to the source image (i.e. the first image). Since, due to this, the random noise included in the source image (i.e. in the first image) and the random noise included in the duplicate image of this first image that has been shifted by one pixel with respect thereto tend mutually to cancel one another out, accordingly the random noise after addition becomes harder to notice, as compared with what would be the case if the addition were to be performed without shifting the duplicate image by one pixel.

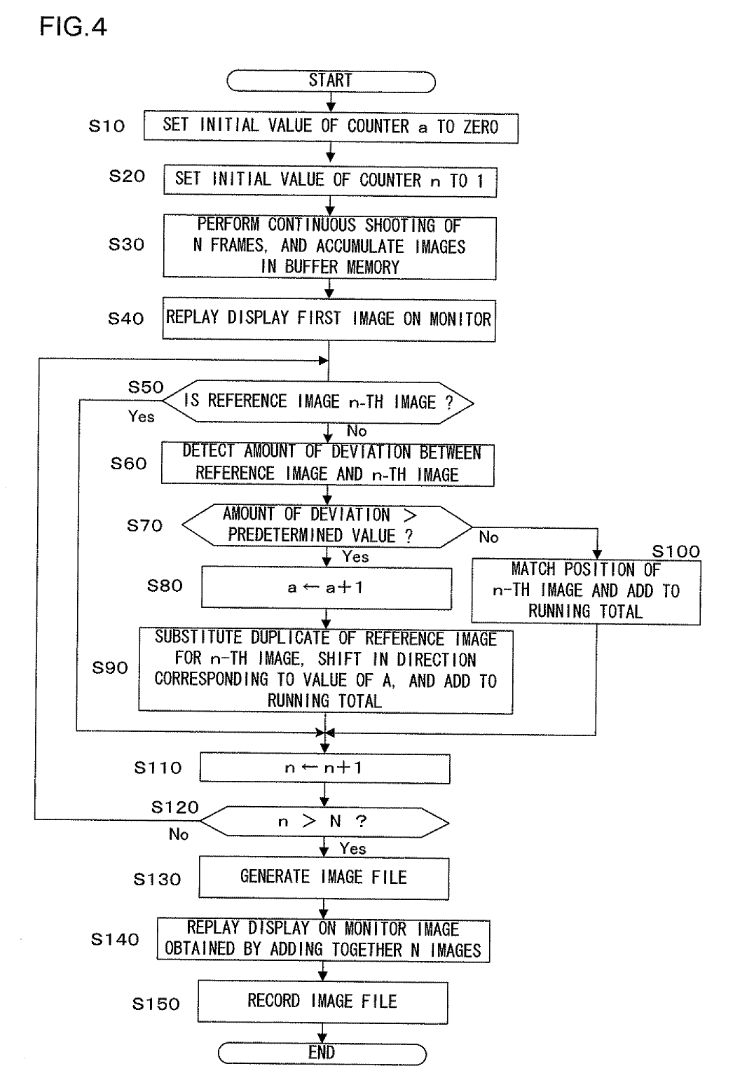

The flow of processing executed by the CPU 16 in the hand-held night scene photography control explained above will now be explained with reference to the flow chart example shown in FIG. 4. When a release button included in the operation members 19 is operated by being depressed in the state in which the hand-held night scene photographic mode is set, the CPU 16 starts the processing shown in FIG. 4.

In a step S10 of FIG. 4, the CPU 16 sets the initial value of a counter “a” to zero, and then the flow of control proceeds to a step S20. This counter “a” is a counter for counting how many of the idiosyncratic images of the type described above are generated, among the N images that are shot by continuous shooting photography.

In the step S20, the CPU 16 sets the initial value of a counter “n” to 1, and then the flow of control proceeds to a step S30, The counter “n” is a loop counter for performing loop processing (in steps S50 through S120) upon the N images that are shot by continuous shooting photography. In this embodiment, the CPU 16 performs addition together of the above described N images, processing relating to unsuitable images, and noise reduction processing by loop processing in which it maintains a running total of the images that are being added together.

In the step S30, the CPU 16 performs continuous shooting of N frames and temporarily stores (i.e. accumulates) the photographic images (RAW data) of these frames in the buffer memory 14, and then the flow of control proceeds to a step S40. It should be understood that the exposure time Tdiv and the number of images N to be shot are determined by the automatic exposure calculation (AE) described above, before the start of the processing shown in FIG. 4.

In the step S40, the CPU 16 displays a replay image based upon the photographic image data of the first frame on the display unit (monitor) 15, and then the flow of control proceeds to a step S50. In this step S50, the CPU 16 makes a decision as to whether or not the reference image is the n-th image. This reference image is an image that is taken as a decision standard for deciding whether or not each of the other images is idiosyncratic, and is specified in advance as being some one of the first through the N-th images. In this embodiment, an example is explained of a case in which it is specified in advance by a program that the first image is to be used as the reference image.

In the first episode of the loop processing (when the counter “n”=1) the CPU 16 reaches an affirmative decision in the step S50, and the flow of control is transferred to a step S110. In this step S110, the CPU 16 adds 1 to the loop counter “n”, and then the flow of control proceeds to a step S120. If in this step S120 the loop counter “n” is not greater than N, the CPU 16 reaches a negative decision, and the flow of control returns to the step S50. If the flow of control has thus returned to the step S50, the loop processing continues.

On the other hand, if in the step 5120 the loop counter “n” is greater than N, the CPU 16 reaches an affirmative decision, and the flow of control proceeds to a step S130. If control reaches this step S130, the loop processing terminates.

And, in the second and subsequent processes of loop processing (when the counter “n”=2 or greater), the CPU 16 reaches a negative decision in the step S50, and the flow of control proceeds to a step S60. In this step S60, the CPU 16 detects the amount of deviation between the reference image (in this example, the first image) and the n-th image, and then the flow of control proceeds to a step S70. This detection of the deviation between these two images is performed by comparing together the RAW data of the two images. For example, the CPU 16 may obtain a movement vector for some photographic subject (i.e. the speed and direction of movement of the photographic subject) that is common to both the reference image and the nth image, and may calculate the amount of deviation of the photographic subject from this movement vector. This photographic subject that is common to both of the images is obtained by using a pattern matching technique in which, for each of the images, similar edge detection is performed to that performed during the position matching described above, and the patterns defined by the edges that are detected are compared between the images.

In the step S70, the CPU 16 makes a decision as to whether or not the amount of deviation that has been calculated is greater than a predetermined value. If the amount of deviation is greater than the predetermined value, the CPU 16 reaches an affirmative decision in this step S70, and the flow of control proceeds to a step S80. If the flow of control reaches this step S80, the CPU 16 considers that the n-th image is an idiosyncratic image, and thus considers this image as being an image that is not suitable for addition to the running total. But if the amount of deviation is not greater than the predetermined value, the CPU 16 reaches a negative decision in the step S70, and the flow of control proceeds to a step S100. If the flow of control reaches this step S100, the CPU 16 considers that the n-th image is not an idiosyncratic image, and thus considers this image as being an image that is suitable for addition to the running total.

In the step S80, the CPU 16 adds 1 to the value of the counter “a”, and then the flow of control proceeds to a step S90. In this step S90, the CPU 16 substitutes a duplicate of the reference image for the n-th image (refer to FIG. 2), and controls the image processing unit 13 so as to shift this duplicate image by some predetermined distance in a direction that corresponds to the value of the counter “a”, and to add this shifted image (refer to FIG. 3) to the running total, and then the flow of control proceeds to a step S110. The addition of the image is performed by adding its RAW data to the running total.

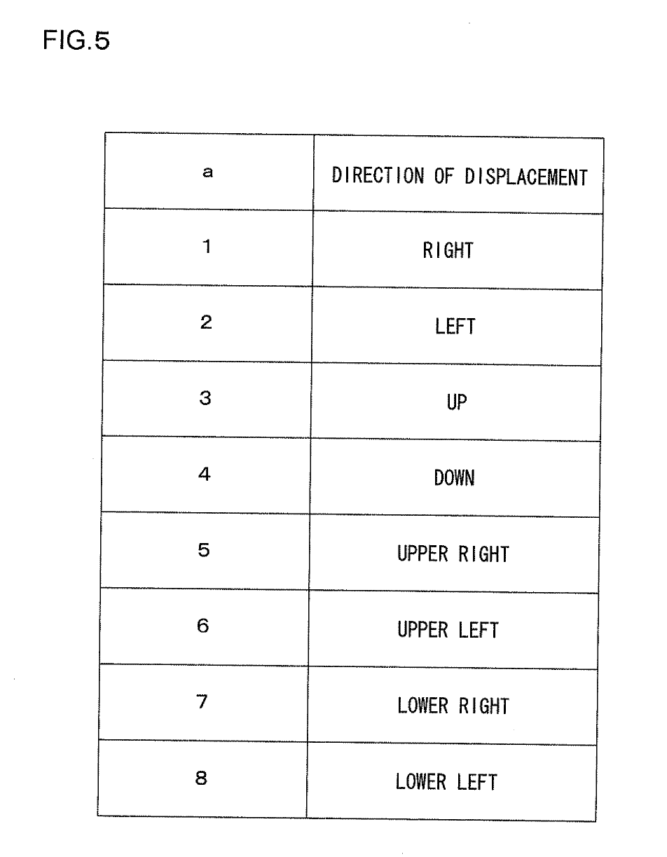

FIG. 5 is a table showing an example of the relationship between the value of the counter “a” and the direction of displacement, In FIG. 5 it is shown that, if for example “a”=1, the duplicate image is shifted with respect to the source image by the amount of one pixel in the rightwards direction in terms of the alignment of the pixels that make up the image. Moreover this table shows that, if “a”=5, the duplicate image is shifted diagonally with respect to the source image by the amount of √2 pixels in the upwards and rightwards direction in terms of the alignment of the pixels that make up the image. This amount of √2 pixels corresponds to a shift in the rightwards direction by one pixel combined with a shift in the upwards direction by one pixel.

In the step S100 of FIG. 4, the CPU 16 performs position matching on the n-th image with the image processing unit 13 and adds it to the running total, and then the flow of control proceeds to the step S110. As described above, the CPU 16 performs edge detection on the basis of the image signals included in the predetermined region (the region that includes a common photographic subject) in the n-th image, and controls the image processing unit 13 to perform position matching so as to align together the pixel positions that make up that edge.

After the loop processing has ended, in the step S130, the CPU 16 creates an image file in which the single image that has been obtained by the image processing unit 13 adding together the N images is stored, and then the flow of control proceeds to the step S140. This image after addition is stored as an image file that has been JPEG compressed by the image processing unit 13. And in the step S140 the CPU 16 displays upon the display unit (i.e. the monitor) 15 a replay image based upon the photographic image data after addition, instead of the replay image that was previously being displayed based upon the photographed image data for the first frame.

In the step S150, the CPU 16 sends a command to the card interface 18 to record the image file upon the storage medium 30, and then the processing shown in FIG. 4 terminates.

According to the embodiment explained above, the following beneficial operational effects are obtained.

(1) This electronic camera 1 includes: the imaging element 12 that captures an image of a photographic subject, and outputs an imaging signal; the buffer memory 14 that temporarily stores a plurality of frame images due to image signals captured successively by the imaging element 12; the CPU 16 that determines amounts of positional deviation generated in the plurality of frame images; the image processing unit 13 that performs position matching of the plurality of temporarily stored frame images and then additive composition thereof, on the basis of the result of this determination of amounts of positional deviation; the CPU 16 that decides for each of the plurality of frame images, on the basis of the amounts of positional deviation, whether or not it is suitable as a subject for additive composition; and the CPU 16 that takes as a subject for additive composition a duplicate image of a frame that has been decided to be suitable, instead of an image of a frame that has been decided to be unsuitable (an idiosyncratic image), and controls the image processing unit 13 so as to perform the additive composition while relatively shifting the duplicate image and the source image by a predetermined amount. Due to this, it is possible appropriately to reduce the influence of random noise included in the image signal.

Generally, it is not possible to perform additive composition of an idiosyncratic image that is included in a set of continuously shot images. If an image for which it is not possible to perform position matching is added into the additive composition, the quality of the image after additive composition decreases. If, in order to avoid this decrease of image quality, simply the above described idiosyncratic image is eliminated, the image after additive composition becomes darker. If a duplicate image is added into the additive composition in order to avoid the resultant image becoming darker, the random noise included in the source image for the duplicate image can easily become apparent. By shifting the source image and the duplicate image by a predetermined amount relative to one another before performing the additive composition in consideration of this reason, since the random noise included in the source image (for example the first image) and the random noise included in the duplicate image of the first image that has been shifted by a predetermined amount tend mutually to cancel one another out, accordingly the random noise after the additive composition becomes harder to notice, as compared with the case in which the additive composition is performed without having shifted one of the images by the predetermined amount.

(2) The image processing unit 13 performs additive composition while performing mutual position matching between the plurality of frame images on the basis of the position of some main photographic subject included in the plurality of frame images, and the CPU 16 controls the image processing unit 13 so that it performs additive composition while shifting the duplicate image, with respect to the source image for the duplicate image, by a predetermined number of pixels in the direction in which the pixels are arrayed. The influence of positional deviation originating in hand-held photography (i.e. of image blur) can be suppressed by the position matching described above. With regard to the influence of random noise that occurs due to addition of the duplicate images, by performing the additive composition while mutually relatively shifting the source image and the duplicate image with respect to one another by a predetermined number of pixels along the direction in which the pixels are arranged, it is possible appropriately to suppress the noise of a frequency component that corresponds to the pixel pitch. This amount of shifting along the direction in which the pixels are arranged is not limited to being one pixel; it may be adjusted as appropriate.

(3) It is arranged for the CPU 16 to decide upon the suitability or unsuitability described above in relation to each of the other frames than the reference frame image (for example the first image) that is determined in advance among the plurality of frame images that are temporarily stored in the buffer memory 14, according as to whether or not the magnitude of the amount of positional deviation occurring between it and the reference frame is less than the predetermined value. Generally, if an idiosyncratic image included in the images that have been continuously shot for which the amount of positional deviation is large is added into the additive composition, the edges of the image after additive composition become indistinct. By making the decision as to suitability or unsuitability on the basis of the magnitude of the amount of positional deviation, it is possible appropriately to eliminate those frame images that might exert a negative influence after additive composition. Moreover, by making the decision as to suitability or unsuitability sequentially against the reference image, for those images that are determined to be unsuitable, it is possible to make the decision of unsuitability at an early stage. It is preferred to enhance the freedom in processing by clearing the regions of the buffer memory in which the frame images that have been determined to be useless are stored.

### Variant Embodiment #1

While, in the above description, an example was explained in which the first image of the N images shot by continuous shooting was taken as being the reference image, it would also be acceptable for the image that is taken as being the reference image not to be the first image photographed, but to be the third or the sixth or the like.

### Variant Embodiment #2

Furthermore, in the above explanation, an example was described in which, if an idiosyncratic image (in this example, the fourth image) is present, a duplicate of the reference image (the first image) is substituted for that idiosyncratic image (the fourth image). However, instead of substituting a duplicate of the reference image (the first image), it would also be acceptable to arrange to substitute a duplicate of some other image that is chosen from the other images that are neither idiosyncratic images nor the reference image (in this case, the second, third, fifth, and sixth images).

### Variant Embodiment #3

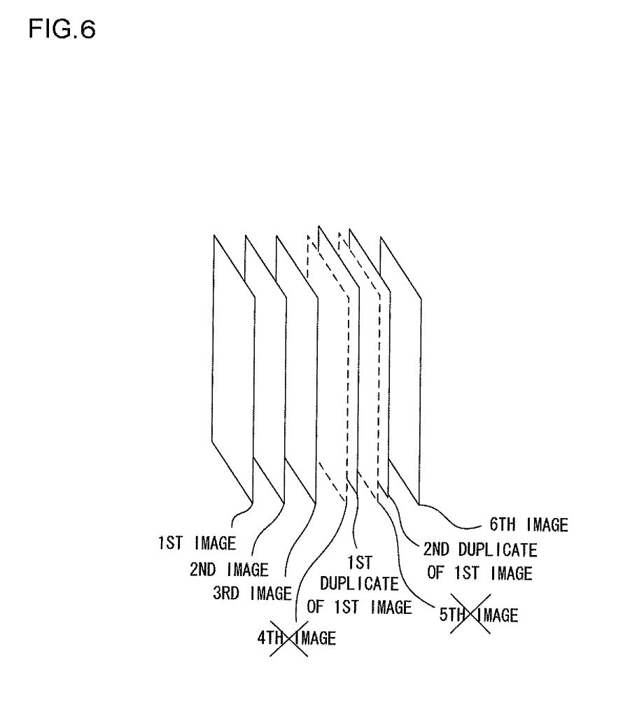

If a plurality of idiosyncratic images are present, it will be acceptable to arrange to create a plurality of duplicate images chosen from the other images that are not idiosyncratic images, and to substitute this plurality of duplicate images for the plurality of idiosyncratic images. In this case, if two or more of the duplicate images that are duplicates of the same source image are added, these two duplicate images should be added after having been shifted with respect to their source image by numbers of pixels in the different direction in which the pixels are arrayed. FIG. 6 is a figure showing an example of this type when continuous shooting photography has been performed divided into N=6 frames. In FIG. 6, it is supposed that a large amount of image blur is present in the fourth image and in the fifth image. From among those among the N=6 images that are not idiosyncratic, i.e. from among the first, second, third, and sixth images, the CPU 16 creates two duplicate images, for example of the first image, and replaces the fourth and the fifth images in which image blur is present (i.e. the two idiosyncratic images) with these two duplicate images (referred to as duplicate #1 and duplicate #2). Due to this, the first image comes to be added into the running total three times as often (in this example, three times), as compared to the other frame images.

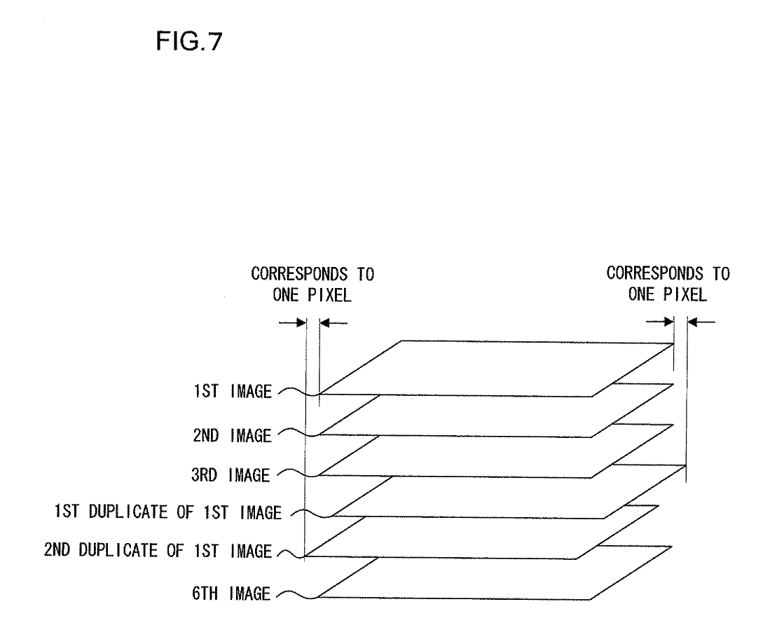

FIG. 7 is a figure for explanation of the position matching in the case of the example shown in FIG. 6. In FIG. 7, the duplicate image (i.e. duplicate #1) that is to be substituted for the fourth image is shifted by one pixel in the rightwards direction as compared to its source image (i.e. the first image). And the duplicate image (i.e. duplicate #2) that is to be substituted for the fifth image is shifted by one pixel in the leftwards direction as compared to its source image (i.e. the first image). According to this variant embodiment #3, since mutual cancellation takes place between the random noise that is included in the source image (i.e. in the first image), the random noise that is included in the duplicate image thereof that has been shifted by one pixel in the rightwards direction (i.e. duplicate #1), and the random noise that is included in the duplicate image thereof that has been shifted by one pixel in the leftwards direction (i.e. duplicate #2), accordingly the noise after addition becomes much harder to notice, as compared with a hypothetical case in which the three copies of the first image are added together in the same position without being shifted relatively to one another.

### Variant Embodiment #4

If a plurality of idiosyncratic images are present, it would also be acceptable, for each of this plurality of idiosyncratic images, to duplicate some other image other than an idiosyncratic image and substitute this duplicate image for that idiosyncratic image, with the image that is thus duplicated being different for each of the idiosyncratic images. For example, in the above case in which the fourth image and the fifth image among N=6 images are idiosyncratic, from among the first, second, third, and sixth images that are not idiosyncratic, the CPU 16 may choose the second image and the third image, may generate one duplicate each of this second image and this third image, may perform shifting on these two duplicates as described above, and may replace the fourth image and the fifth image that are images containing image blur (i.e. that are idiosyncratic images) with these two duplicates respectively.

When performing position matching, the CPU 16 will shift the duplicate of the second image, i.e. the one that is to be substituted for the fourth image, by one pixel in the rightwards direction with respect to its source image (i.e. the second image). Since, due to this, mutual cancellation takes place between the random noise that is included in the source image (the second image) and the random noise that is included in its duplicate image that has been shifted by one pixel with respect thereto, accordingly the noise becomes harder to notice after addition, as compared with a hypothetical case in which the two images were added together in the same position without one of them being mutually relatively shifted. Similarly, the CPU 16 will shift the duplicate of the third image, i.e. the one that is to be substituted for the fifth image, by one pixel in the rightwards direction with respect to its source image (i.e. the third image). Since, due to this, mutual cancellation takes place between the random noise that is included in the source image (the third image) and the random noise that is included in its duplicate image that has been shifted by one pixel with respect thereto, accordingly the noise becomes harder to notice after addition, as compared with a hypothetical case in which the two images were added together in the same position without one of them being mutually relatively shifted.

### Variant Embodiment #5

In the above explanation, an example was discussed in which one reference image was determined upon in advance from among the N images, and the amount of image blur of each of the other images was determined by obtaining the difference between that other image and this reference image. Instead of this, it would also be acceptable to arrange to provide a structure in which the determination of the image blur amount of each image was performed by obtaining the differences between that image, and the images that were shot just previously and just afterwards.

### Variant Embodiment #6

In the above explanation, among the N images obtained by continuous shooting photography divided over N shots, an image for which the amount of image blur was greater than some predetermined value was taken as being an idiosyncratic image. However, it would also be acceptable to arrange to consider, as being an idiosyncratic image, in addition to an image in which the amount of image blur is large, also an image for which the difference in luminance from the luminance of the reference image is greater than a predetermined luminance difference value. For example, if during night scene photography momentarily a shaft of illumination light from the exterior impinges upon the photographic scene, an image that is photographed at that moment could be excluded from the images that are to be subjects for addition.

### Variant Embodiment #7

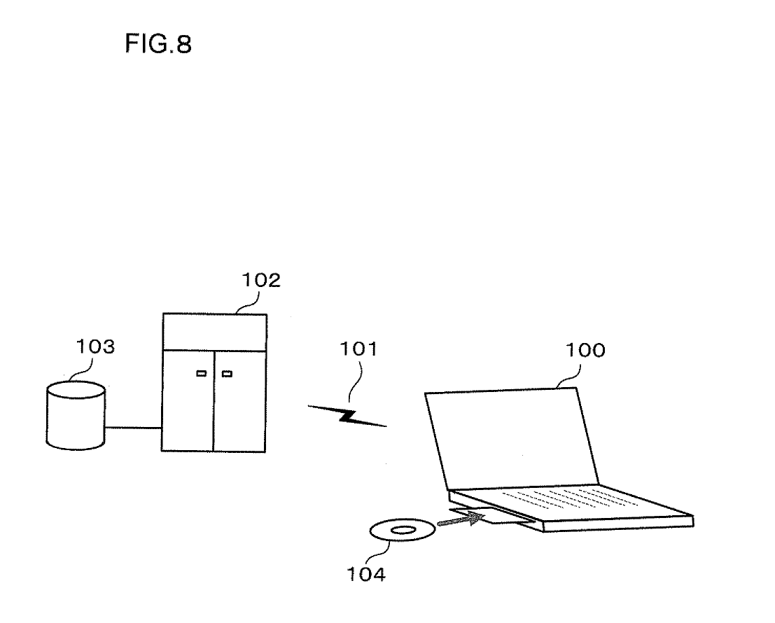

It would also be acceptable to arrange to provide a night scene image composition processing device by executing the image composition program that performs the processing of FIG. 4 upon a computer device such as the one shown in FIG. 8. If the image composition program is to be used by being read in to this personal computer 100, then after the program has been loaded in to a data storage device of the personal computer 100, the personal computer 100 may be used as an image composition processing device by causing it to execute that program. However, instead of the continuous shooting photographic processing of the step S30, image reading in processing is performed to read in N images that have been continuously shot during hand-held night scene photography, and then the flow of control proceeds to the step S40. In this case, these N continuously shot photographic images are temporarily stored in a working memory of the computer device 100, not shown in the figures.

The program may be installed upon the personal computer 100 by a recording medium such as a CD-ROM or the like upon which the program is stored being loaded into the personal computer; or the program could also be installed upon the personal computer 100 by the method of transmitting it via a communication circuit 101 such as a network or the like. If the communication circuit 101 is employed, the program should be stored upon a hard disk device 103 or the like of a server computer 102 that is connected to the communication circuit 101. Thus, this image composition program may be supplied as a computer program product in various formats, such as upon the storage medium 104 or via the communication circuit 101 or the like.

The above described embodiments are examples, and various modifications can be made without departing from the scope of the invention.

What is claimed is:

1. A camera, comprising:
an image-capturing unit that captures successive images of a photographic subject, and generates a plurality of frame images;
a storage unit that temporarily stores the plurality of frame images generated by the image-capturing unit;
a positional deviation amount determination unit that determines an amount of positional deviation generated in each of the plurality of frame images;
an image composition unit that, on the basis of the results of determination by the positional deviation amount determination unit, positionally matches the plurality of temporarily stored frame images, and then performs additive composition thereof;
a decision unit that decides whether or not each of the plurality of frame images is suitable to be a subject for the additive composition, on the basis of the amounts of positional deviation; and
a control unit that, if a negative decision has been reached by the decision unit for at least one of the plurality of frame images, selects as a source image a frame image that has been decided by the decision unit as being suitable, takes a duplicate image of the source image as a subject for the additive composition instead of the frame image for which a negative decision has been reached by the decision unit, and controls the image composition unit so as to perform the additive composition while relatively shifting one of the duplicate image and the source image by a predetermined amount relative to the other.

2. A camera according to claim 1 wherein,
if two or more frame images are present for which a negative decision has been reached by the decision unit, the control unit creates two or more duplicate images from the single source image, takes the duplicate images as subjects for the additive composition and controls the image composition unit so that it performs the additive composition while shifting the two or more duplicate images by predetermined amounts in different directions relative to the single source image.

3. A camera according to claim 1 wherein,
if two or more frame images are present for which a negative decision has been reached by the decision unit, the control unit creates the duplicate images from each of two or more source images, takes the duplicate images as subjects for the additive composition and controls the image composition unit so that it performs the additive composition while relatively shifting one of each of the duplicate images and source image by a predetermined amount relative to the other.

4. A camera according to claim 1, wherein,
according as to whether or not the magnitudes of the amounts of positional deviation occurring between a reference frame image and the other frame images other than the reference frame image are less than a predetermined value, the decision unit makes the decision as to suitability or unsuitability in relation to the other frame images, the reference frame image being determined in advance among the plurality of frames that are temporarily stored in the storage unit.

5. A camera according to claim 4, wherein
the control unit selects the reference frame image as the source image, and controls the image processing unit so as to create the duplicate image by duplicating the selected source image.

6. A camera, comprising:
an image-capturing unit that captures successive images of a photographic subject, and generates a plurality of frame images;
a storage unit that temporarily stores the plurality of frame images generated by the image-capturing unit;
a determination unit that determines a relative amount of positional deviation between the plurality of frame images;
a decision unit that makes a decision as to whether or not the amount of positional deviation is larger than a predetermined value; and
an additive composition unit that:
performs additive composition of the plurality of frame images after having performed position matching thereof on the basis of the amounts of positional deviation, if the amounts of positional deviation of all of the plurality of frame images are decided to be smaller than the predetermined value by the decision unit; and
selects at least one frame image that has been decided by the decision unit as being suitable as a source image, relatively shifts one of a duplicate of the source image and the source image by a predetermined amount relative to the other, and performs the additive composition using the duplicate image instead of the frame image that has been decided as being unsuitable, if the amount of positional deviation of at least one of the plurality of frame images is decided to be greater than the predetermined value by the decision unit.

7. A manufactured program product that can be read by a computer, on which is recorded an image composition program that can be executed by a computer, the image composition program comprising:
a first process of reading in a plurality of frame images that have been captured successively;
a second process of deciding upon amounts of positional deviation occurring between the plurality of frame images;
a third process of deciding upon its suitability or unsuitability as an additive composition subject for each of the plurality of frame images that have been read in, if additive composition is performed after having performed position matching of the plurality of frame images on the basis of the results of decision in the second process;
a fourth process of selecting a frame image that has been decided to be suitable as a source image, and creating a duplicate image by duplicating the source image;
a fifth process of substituting the duplicate image for a frame image that has been decided as being unsuitable;
a sixth process of shifting the duplicate image with respect to the source image by a predetermined amount; and
a seventh process of performing the additive composition of the plurality of frame images executed after the first process through the sixth process.
